(19) United States
(12) Patent Application Publication
(10) Pub. No.: US 2024/0207692 A1
(43) Pub. Date: Jun. 27, 2024

(54) A BALL MARKING DEVICE

(71) Applicant: CLAPARO INNOVATIONS LTD, Cheltenham Gloucestershire (GB)

(72) Inventor: David Townsend, Cheltenham (GB)

(21) Appl. No.: 18/557,708

(22) PCT Filed: Apr. 26, 2022
(86) PCT No.: PCT/GB2022/051046

§ 371 Date: Oct. 27, 2023

(30) Foreign Application Priority Data
Apr. 28, 2021 (GB) 2106048.8

(51) Int. Cl. A63B 45/02; A63B 102/02; B41F 17/34; B41L 13/04; B41L 13/12

(52) U.S. Cl. CPC A63B 45/02; B41F 17/34; B41L 13/04; B41L 13/12; A63B 2102/02; B41P 2217/61

(57) ABSTRACT

A ball marking device 10 comprising a device body including a ball holder 18 defining a ball receiving area and a pen holder 20 extending from the ball holder 18 for releasably retaining a pen 14 for marking the ball 11.

The present invention relates to a ball marking device and particularly but not exclusively to a tennis ball marking device. The present invention also relates to a removable stencil for use with the ball marking device.

### BACKGROUND TO THE INVENTION

Tennis balls are known to deteriorate with use, and in a professional match, for example, tennis balls are replaced with new balls throughout. Professional players generally hit the ball harder than amateur players, which increases the rate of compression of the ball when it hits the ground, thus degrading the bounce of the ball more quickly. Replacement of the balls during a match ensures that the players are using consistently good balls with similar properties, thus not giving either player an advantage to their style of play.

Balls used in professional tournaments are still regarded as good quality and are generally sold off for amateur play, since the bounce quality is good enough for most players.

The air pressure inside a tennis ball also reduces over time, thus also reducing bounce height. Hence, even some amateur players like to start a match with a new tube of balls. There is therefore an advantage in knowing when a ball is first used on court.

It is not unreasonable to pay say £2 per ball, and so if balls are replaced for each match, the cost of balls can quickly build, even for an amateur player.

When playing tennis at a tennis club, tennis balls being used on adjacent courts often get mixed up and it is difficult to tell at first glance, whose ball belongs to who. Many balls can be in use at a time, and it can be difficult, if not impossible, to quickly distinguish between the balls. If a brand new ball is suddenly replaced accidentally with a much older ball, this can spoil the match play and can lead to more expense as the ball is replaced.

It has been known to try and mark tennis balls for many years to try and mitigate these problems. For example, as early as 1924 a ball stencil was proposed in GB 217435, to assist in the marking of a tennis ball. However, these stencils are not convenient to use and are not easily changed.

As time has progressed, various heated devices have been proposed to burn a mark on a ball. However, this is considered undesirable, because it can marginally change the properties of the ball. Spring loaded marking devices have also been proposed, as have other stamping type devices such as the applicant's other invention set out in British patent application GB 2009547.7.

Aside from the alternative device disclosed in the applicant's existing British patent application, there has not been a device which can safely, conveniently, consistently and cleanly mark a tennis ball without affecting the ball itself.

When marking balls, or other similar spherical objects, for other purposes such as arts and crafts, it can be difficult to apply consistent markings. Furthermore, the applied marking medium can be transferred onto the hands and clothing, making for an unpleasant experience.

It is an object of the present invention to reduce or substantially obviate the aforementioned problems.

### STATEMENT OF INVENTION

According to a first aspect of the present invention there is provided a ball marking device comprising a device body including a ball holder defining a ball receiving area and a pen holder extending from the ball holder for releasably retaining a pen for marking the ball.

The provision of an all-in-one ball and pen holder allows a ball to be held firmly and securely while being marked by a pen conveniently to hand in the holder. The ball can be held without needing to touch the ball, thereby reducing the risk of smudging the markings or getting ink, paint, dye or other similar marking means on clothes or hands.

The ball marking device may be a tennis ball marking device.

A stencil receiving portion for receiving a removable stencil may be provided. The stencil receiving portion may be provided in or on the ball holder.

The stencil receiving portion may be in communication with the ball receiving area. The stencil receiving portion may include a bore extending through the ball holder to the ball receiving area for receiving the removable stencil.

A stencil receiving portion allows the removable stencil to be placed in the same position each time the ball marking device is used. Moreover, it allows for stencils with different icons to be interchanged and swapped. A further advantage provided is that a ball with a faded marking can be re-marked.

A flange extending out from a bore wall may be provided for locating the removable stencil in a position for marking the ball. At least a portion of the removable stencil may be located within the bore. The flange may extend towards an axis of the bore. The flange may be disposed a predetermined distance from an edge of the bore wall. A plurality of spaced apart flanges may be provided around the bore.

The flange effectively provides a shelf on which the removable stencil sits. By spacing the flange at a predetermined distance, it is possible to provide a substantially flush finish between the edge of the removable stencil and the edge of the bore wall.

A stencil retaining means may be provided to retain a removable stencil in a position to mark the ball.

The stencil retaining means may comprise a collocating connector for engaging with a corresponding connector on the removeable stencil. The collocating connector may include a tab receiving recess, such as a slot, disposed to the bore. The tab receiving recess or slot may be shaped to allow a tab of the removable stencil to be inserted into the recess or slot and the removable stencil to be rotated into position.

The stencil retaining means may comprise retaining tabs extending from an edge of the bore. The retaining tabs may engage with retaining grooves on the removable stencil.

The use of retaining means allows the stencil to be held in place without the user needing to use a hand. It also provides a means to retain and align the removable stencil in a position to mark the ball in a repeatable manner.

A resilient catch may be provided for retaining the removable stencil in a position to mark the ball. The resilient catch may be biased towards a locking position for engagement with a portion of the removable stencil. The resilient catch may be actuated by a camming action between the catch and a surface of the removable stencil.

The device may be formed from plastic or other suitable materials for example carbon fibre, fibreglass, or carbon composites.

The device body may comprise two parts or elements. The device body may be a clamshell body. The elements may be coupled together by fasteners. The fasteners may include tabs and slots. The elements of the clamshell may be glued or welded together.

The resilient catch may be integrally formed with the device. Preferably, the resilient catch may be integrally formed with the device body. More preferably, the resilient catch may be formed by two elements, each element of the resilient catch may be disposed on a part or element of the device body.

The resilient catch may be provided separately to the device. That is to say, the resilient catch may be a separate part or element of the device. Put another way, the resilient catch may not be integrally formed with the device body. The resilient catch may include a catch body, the catch body being dog-leg shaped. The resilient catch may be disposed between the two parts or elements of the device body. The resilient catch may be secured to the device when the elements or parts of the device body are coupled together.

An aperture suitable for marking and/or for aligning the ball may be provided in a wall of the ball holder. The aperture may extend through the wall of the ball holder to the ball receiving area. An aperture suitable for marking and/or for aligning the ball may be provided in each part of the body. The aperture may be an elongate slot.

The aperture allows a user of the device to align a feature of a ball with the aperture. Taking tennis balls as an example, the seam may be located so as to be visible through the aperture, preferably the seam will bisect the aperture.

The ball receiving area may be concave. The ball receiving area may be sized and shaped to fit a tennis ball.

The ball holder may include a ball alignment means. The ball alignment means may position the ball in substantially the same position in the device for consistent marking. The ball alignment means may be provided by a shaped edge of a wall of the ball holder. The shaped edge may correspond to the shape of the seam of the ball. The shaped edge may comprise a curve or curves which substantially match at least part of the seam line of a standard tennis ball. The seam on a tennis ball divides the ball into two equal portions and substantially describes a line of four continuous semicircles.

The shaped edge of the wall and the apertures may be used in conjunction or as separate aligning means.

A pen receiving slot may be included in the pen holder.

A pen attachment means may be provided to attach the pen to or in the pen holder.

A resilient pen holding means may be provided in the pen holder. Preferably, the resilient pen holding means may be provided in the pen receiving slot. The resilient pen holding means may be provided by two biased catches which engage with the pen.

One end of the pen slot may include a cap for receiving a portion of the pen, preferably the pen nib. The cap may be removable from the device. The cap may be cylindrical with one end being closed.

A lanyard, or similar, connector may be provided.

The ball marking device may be operated handheld, e.g., it may be a handheld device. A handheld device allows a user to hold the ball within the device in a single hand while using a pen in the other hand to apply the ink through the stencil. The pen holder may serve as a handle for the device.

A pen may be provided with the device. The pen may be suitable for marking the ball.

A removable stencil may be provided with the device.

At least one internal rib may be provided in the ball receiving area. The rib(s) may engage with the ball once it is received in the ball receiving area. The rib(s) assist in holding the tennis ball in a desired position in the device. The tennis ball may be slightly depressed onto the ribs in use, i.e., there may be some minor deflection, and this takes up any minor variance in size between balls.

The ball receiving area may be sized and shaped to correspond to the size and shape of the ball.

According to a second aspect of the present invention there is provided a removable stencil for use with the ball marking device of the first aspect. The removable stencil comprises a stencil having a substantially concave surface for substantially corresponding to a curve of a ball and a connector for in use engaging with a collocating connector on the ball marking device.

The provision of a removable stencil allows for multiple stencils with different icons to be provided for a single marking device. The provision of a connector which engages with a corresponding collocating connector on the marking device provides a reliable way to ensure that the stencil is secured in position in a repeatable manner.

The stencil may have a stencil body.

A plurality of encoding apertures may be disposed around the stencil for marking the ball with a code. The plurality of encoding apertures may be provided in combination with the main icon provided in the stencil.

The plurality of encoding apertures may be disposed towards the periphery of the removable stencil. The space for the main stencil icon is maximised by providing the encoding apertures toward the peripheral edge of the removable stencil.

A tab may provide the connector. A tab connector provides a way of repeatably locating the removable stencil to the ball marking device. The tab may be formed from cutout portions of the stencil. The tab may extend from an edge of the stencil.

A catch retaining tab may be provided for engaging with a catch of the ball marking device.

A retaining groove for engaging with a retaining tab of the ball marker may be provided. The retaining groove may be provided around the periphery of the stencil.

According to a third aspect of the present invention there is provided a kit of parts for marking a ball. The kit of parts comprises a ball marking device according to the first aspect of the present invention and a pen suitable for marking the ball.

The kit of parts may be provided with at least one removable stencil. The removable stencil may be the removable stencil according to the second aspect of the present invention.

The stencil may be integral with the ball holder.

### BRIEF DESCRIPTION OF THE DRAWINGS

For a better understanding of the present invention, and to show more clearly how it may be carried into effect, reference will now be made by way of example only to the accompanying drawings, in which:

FIG. 1 show a perspective view of a ball marking device according to a first embodiment of the present invention;

FIG. 2 shows an exploded perspective view of the ball marking device in FIG. 1 without a ball;

FIG. 3 shows a front view of the ball marking device of FIG. 1 without the removable stencil;

FIG. 4 shows a front view of the ball marking device in FIG. 3 with the removable stencil;

FIG. 5 shows a side view of the ball marking device of FIG. 1 without the removable stencil;

FIG. 6 shows a side view of the ball marking device in FIG. 3 with the removable stencil;

FIG. 7 shows a rear view of the ball marking device of FIG. 1 without the pen;

FIG. 8 shows a rear view of the ball marking device of FIG. 7 with the pen;

FIG. 9 shows a perspective view of a removable stencil according to an embodiment of the present invention;

FIG. 10 shows an exploded perspective view of the ball marking device according to a second embodiment of the present invention; and

FIG. 11 shows a cut-out perspective view of the ball marking device of FIG. 10.

### DESCRIPTION OF PREFERRED EMBODIMENTS

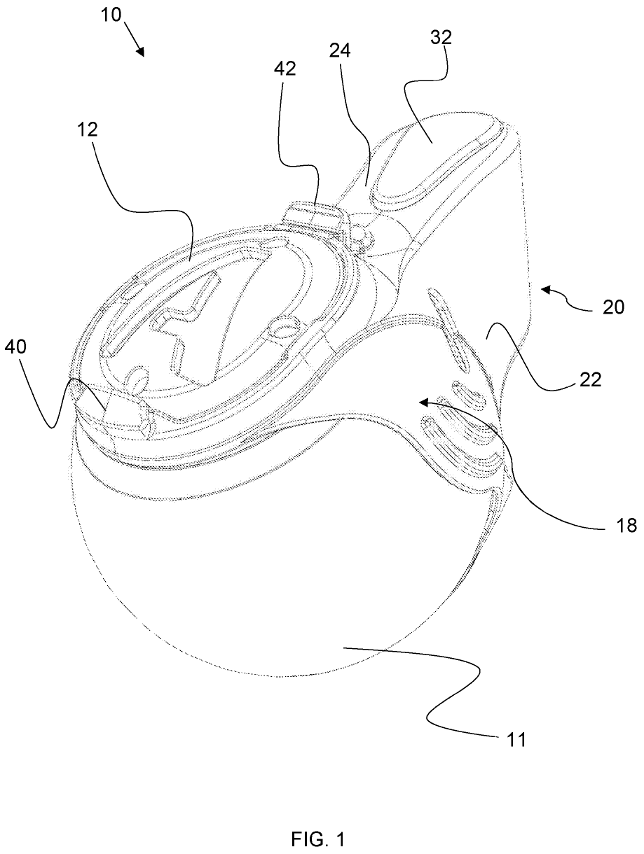

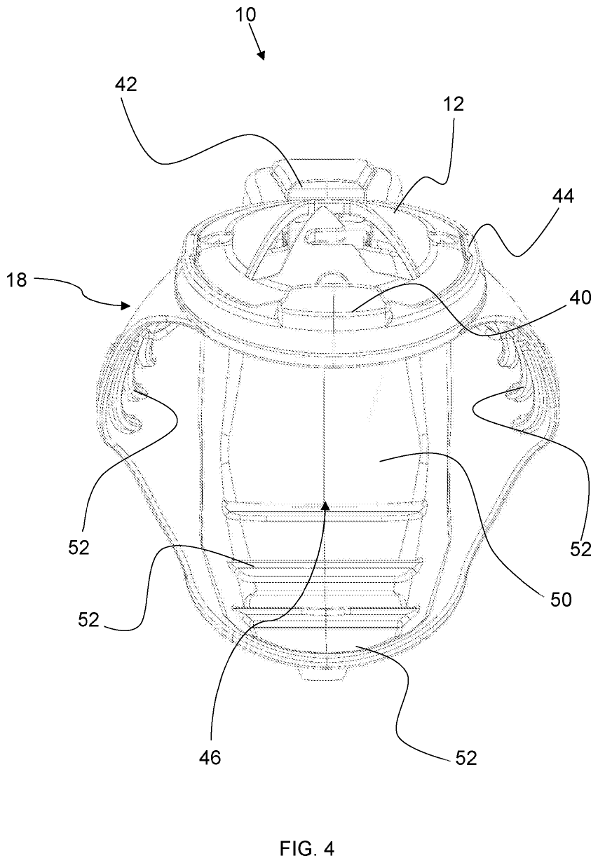

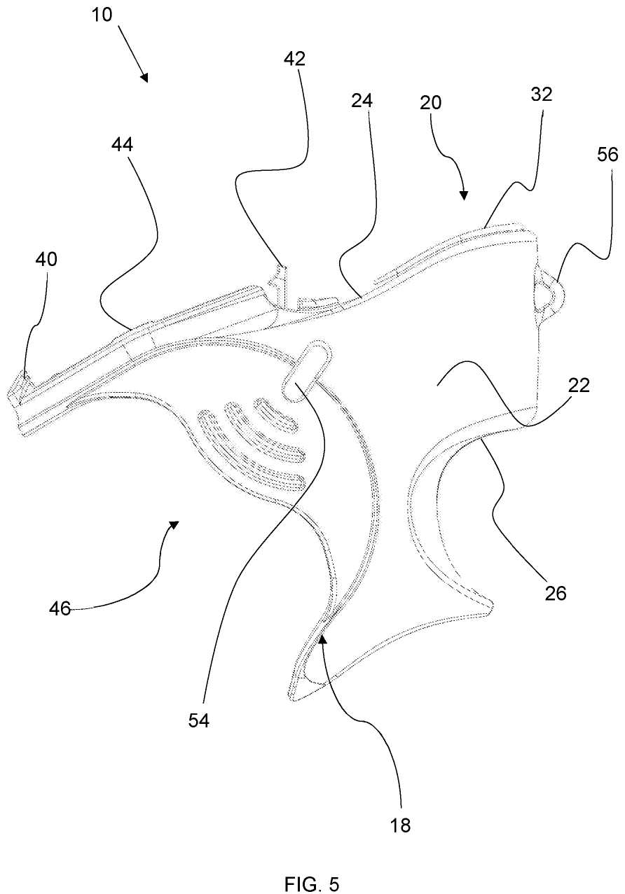

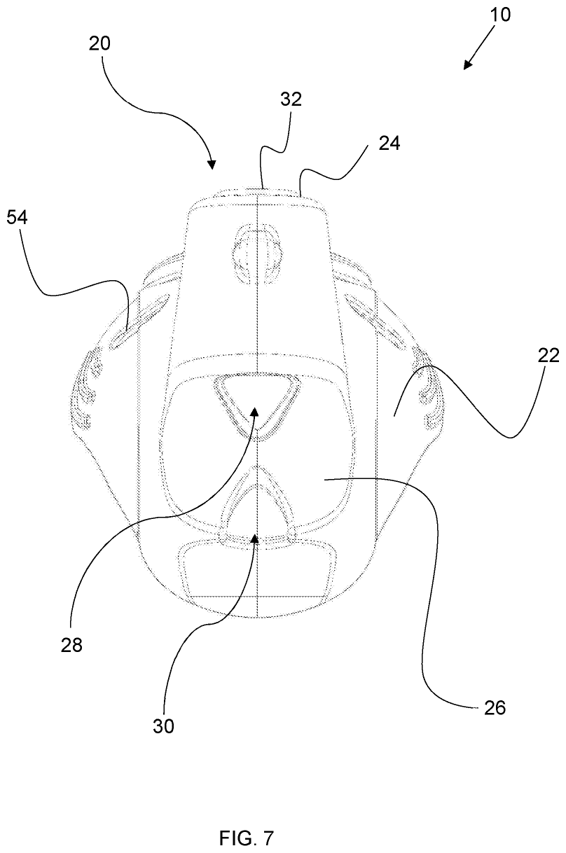

Referring to FIGS. 1 to 8, a first embodiment of a ball marking device is generally indicated at 10.

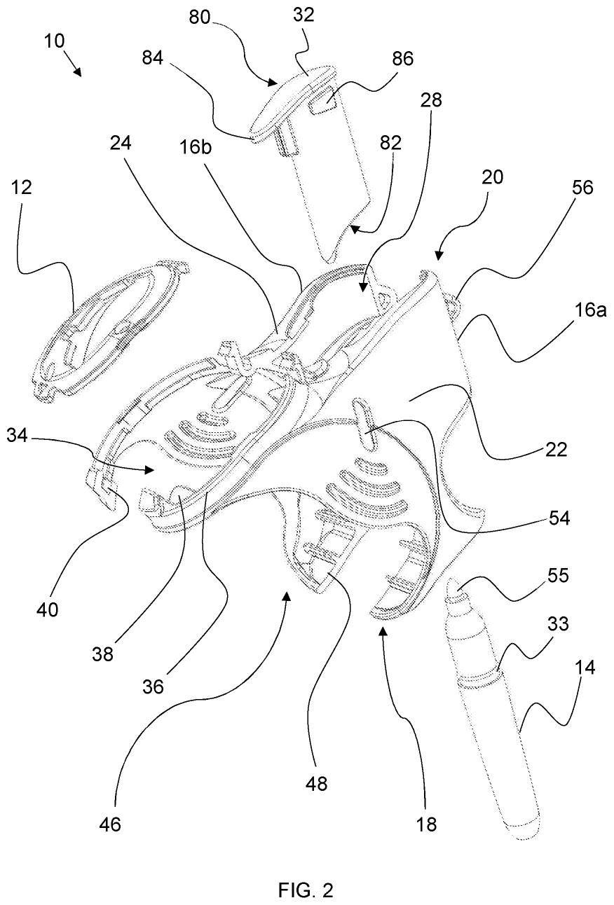

FIG. 1 shows the device 10 holding a ball 11, preferably a tennis ball. In FIGS. 2 to 8 the ball 11 has been removed to show the device 10 more clearly.

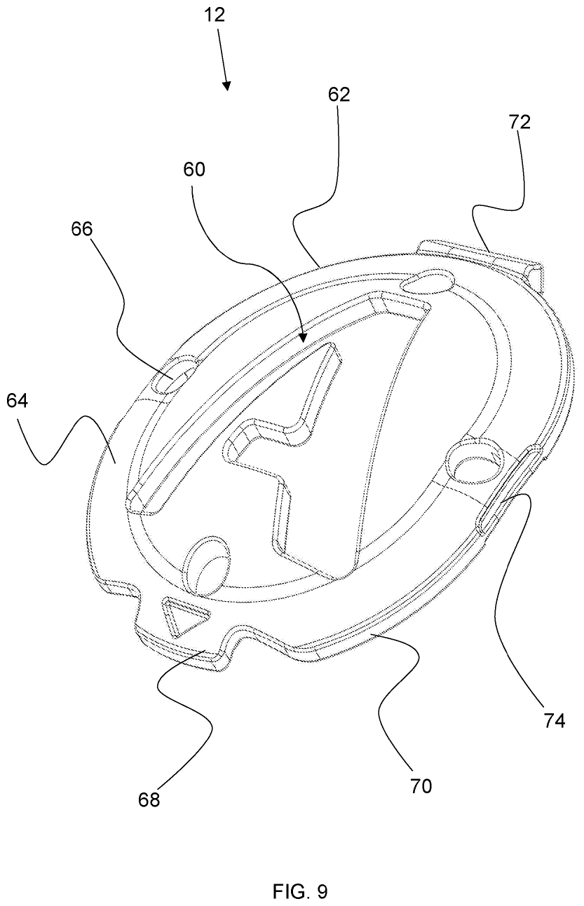

The device 10 may include a removable stencil 12 which will be discussed in more detail in relation to FIG. 9 below. A removable pen 14 may also be provided and is visible in some Figures.

In the first embodiment, the device 10 is manufactured in two parts 16a, 16b as best shown in FIG. 2. Each part 16a, 16b is symmetrical and comprises a portion of a ball holder 18 and a pen holder 20. The ball holder 18 and pen holder 20 are formed when both parts 16a, 16b are coupled together using coupling means such as fasteners, glue or welding. Each part 16a, 16b includes a substantially curved side wall 22 which extends between both the ball holder portion 18 and pen holder portion 20. The curve of the side wall about the ball holder portion 18 has a radius of curvature similar to that of the ball to be marked, such as a standard tennis ball.

The pen holder 20 includes an upper wall 24, a bottom wall 26 and a portion of the curved side wall 22 on each part 16a, 16b. The bottom wall 26 is curved and produces an arcuate shape.

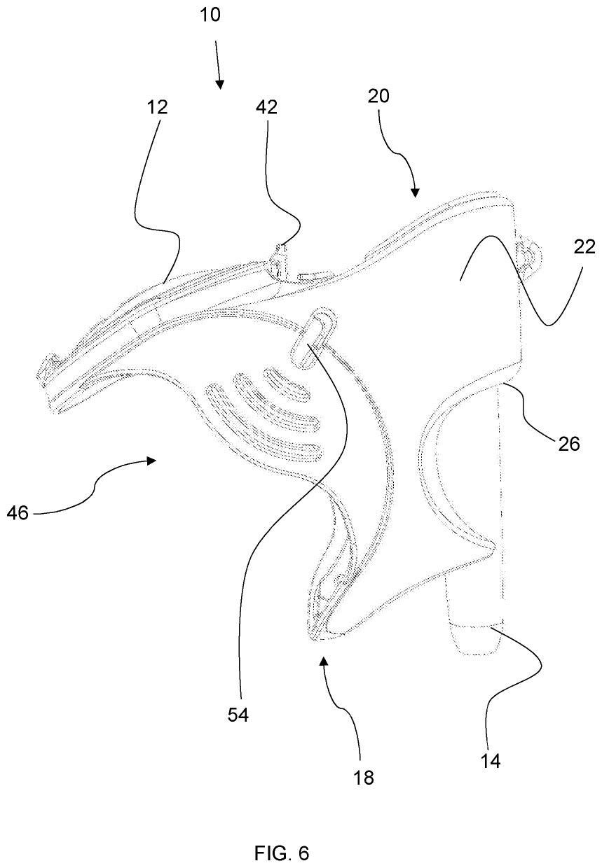

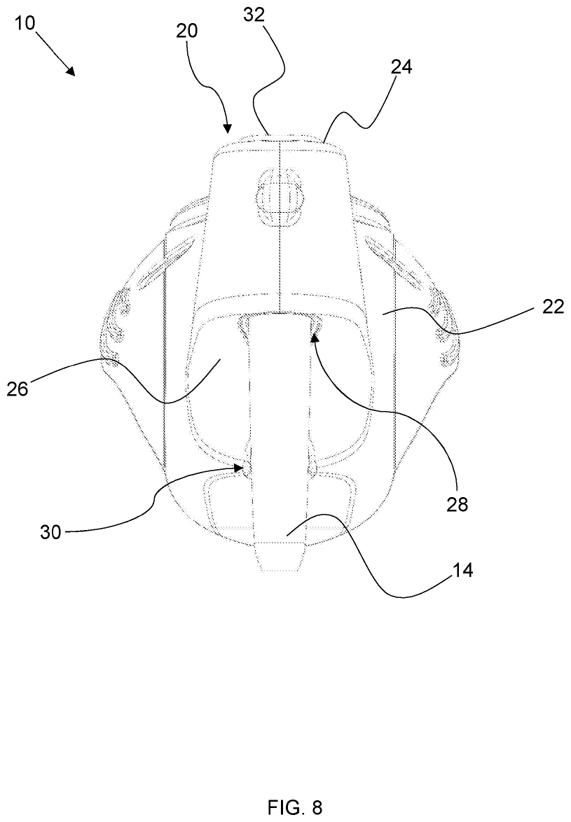

A slot 28 for receiving the pen 14 extends from the upper wall 24 to the bottom wall 26. A further cut out 30 is provided in the bottom wall 26 spaced away from the slot 28. The cut out 30 is concentric with the slot 28 so that when the pen is received in the slot 28 it is also located within the cut out 30, as can be readily seen in FIGS. 6 and 8.

A pen cap 32 is disposed in the end of the slot 28 proximate the upper wall 24. The pen cap 32 includes a bore for receiving the pen 14. The pen cap 32 is preferably removable from the slot 28. Resilient catches (not visible in the drawings) for releasably retaining the pen are provided in the bore of the cap 32 for interfacing with a groove 33 on the pen 14.

The pen cap 32 further includes a closed end 80 and an open end 82. The bore extends from the open end 82 until the closed end 80.

A flange 84 extends around the peripheral edge of the closed end 80. The closed end flange 84 extends more or further on a portion of a curved side of the pen cap 32 forming a substantially oval-shaped lid over the closed end 80. A lower surface of the closed end flange 84 is disposed in a recessed area of the body of the device and abuts a surface of the recess.

The pen cap 32 includes tabs 86 (shown in FIG. 2) for securing the pen cap 32 to the slot 28. The pen cap tabs 86 are disposed towards the closed end. In use, a pen cap tab 86 is provided on either side of the pen cap 32 facing the side walls 22 of the pen holder 20. The pen cap 32 is securely held in place in the slot 28 by walls of the device body being located between the closed end flange 84 and the tabs 86.

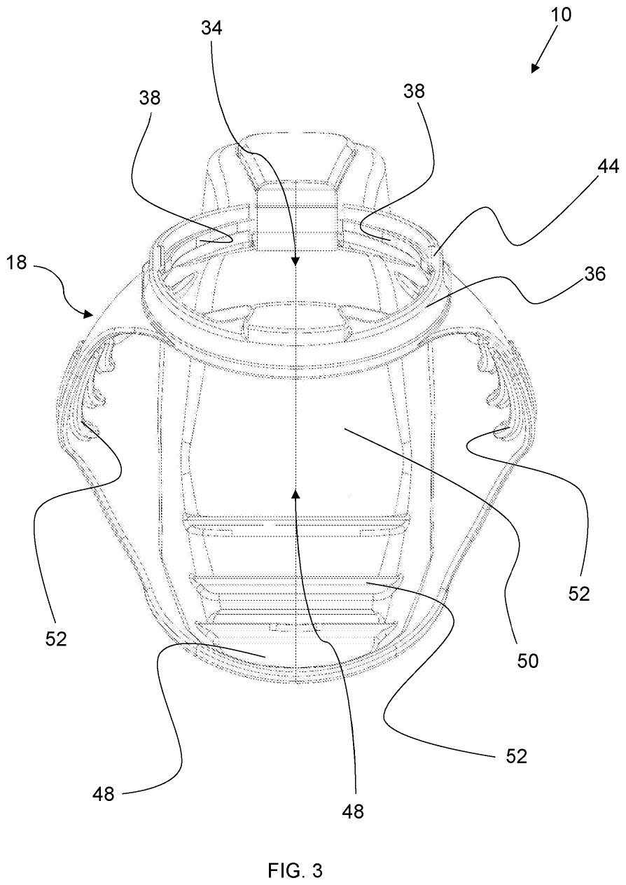

A stencil receiving bore 34 is provided in an upper section of the ball holder 18, shown for example in FIG. 3. The stencil receiving bore 34 is defined by a bore wall 36 when parts 16a, 16b are coupled together. Each part 16a, 16b, includes a portion of the bore wall 36. The bore wall 36 extends from the upper section of the ball holder 18. The stencil receiving bore 34 and bore wall 36 define the stencil receiving portion of the device 10.

Flanges 38 are provided in the stencil receiving bore 34 and are spaced by a predetermined distance from the edge of the bore wall 36. The flanges 38 extend from the inner diameter of the bore wall 36 towards a central axis of the stencil receiving bore 34.

A stencil retaining slot 40, shown in FIG. 2, is provided in the bore wall 36. In use, the stencil retaining slot 40 receives a tab 68 formed on the removable stencil 12, described further below.

A stencil retaining catch 42 is provided proximate the stencil receiving bore 34. An engagement lug and arm provide the stencil retaining catch. The catch 42 is biased towards a locking position. The lug includes an angled surface which forms a camming surface to allow the catch 42 to be moved from the locking position by insertion of the removable stencil 12 into the stencil retaining bore 34. The stencil retaining catch 42 is opposite the stencil retaining slot 40.

In the first embodiment, the stencil retaining catch 42 has two parts, each part which forms the retaining catch 42 is integrally formed with a part 16a, 16b of the body.

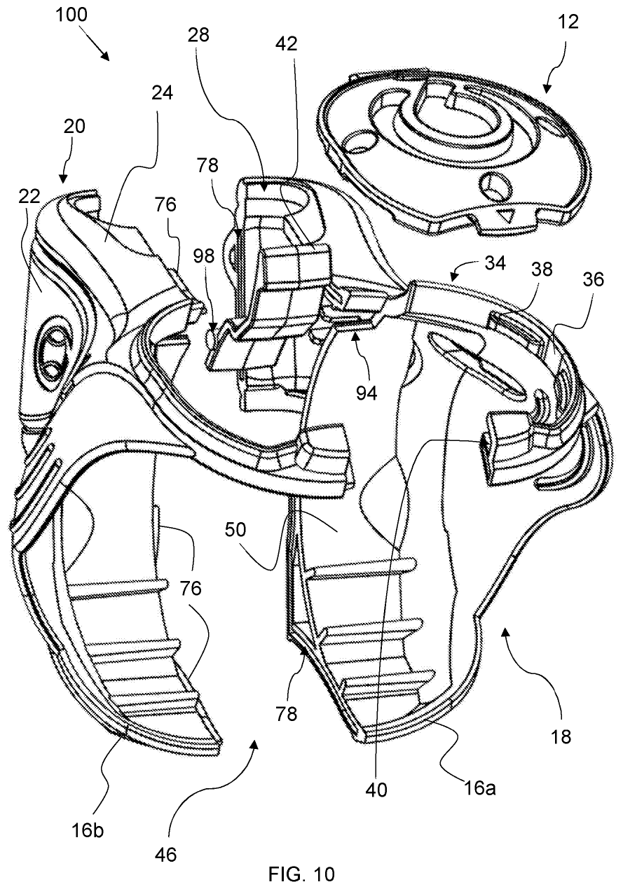

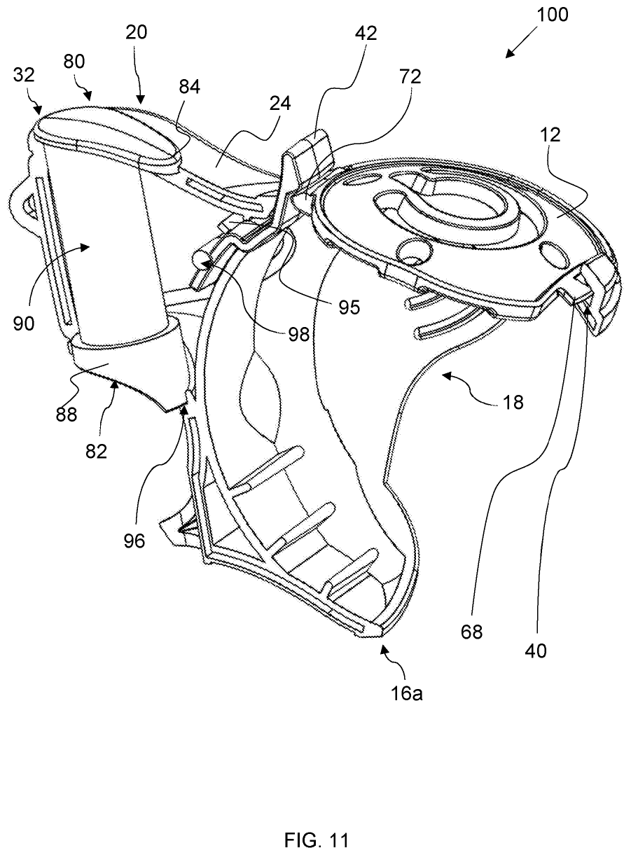

Stencil retaining tabs 44 extend from the bore wall 36. In use, the stencil retaining tabs 44 interface with grooves in the removable stencil 12. In other embodiments, such as that shown in FIGS. 10 and 11, no stencil retaining tabs 44 may be provided.

A ball receiving area 46 is defined by the portion of the curved side wall 22 about the ball holder 18, the stencil receiving portion in the upper portion of the ball holder 18, a lower wall 48 and an inner wall 50. The inner wall 50 separates the ball holder 18 from the pen holder 20.

An edge of the curved side wall 22 proximate the ball receiving area 46 is curved to substantially follow the seam of a ball 11. This enables positioning of the ball 11 in an exact position.

At least some of the edges of the walls which define an opening for the ball receiving area 46 may be substantially shaped to follow the seam of a ball 11.

Ribs 52 extend from at least some of the inner surface of the walls which define the ball receiving area 46. The ribs guide and hold the ball 11 placed in the device 10.

Apertures 54 are provided in the ball holder 18. The apertures 54 extend through the curved side wall 22 to the ball receiving region 46. The apertures may be sized and shaped so as to allow a nib 55 of the pen to be inserted. The apertures 54 may be used as an aligning means by locating the seam of the ball 11 so as to be visible through the apertures 54.

A lanyard connector 56 extends from the pen holder 20. The lanyard connector 56 is formed by a curved protrusion with an aperture.

FIG. 9 shows an embodiment of the removable stencil 12 with an A-shaped icon stencil 60. However, in other embodiments the icon may be a number, letter, image or similar. The icon may also comprise a group of numbers, letters or images. An image can include such things as an emoji, imaginary character or real character etc. The icon may be formed during manufacturing based on user customisation. The removeable stencil 12 in FIGS. 10 and 11 includes an icon such as a logo.

A stencil body 62 is made from a suitable material, such as plastic. In the embodiments, the stencil body is substantially circular but in other embodiments different shapes may be provided to fit the stencil receiving bore.

A lower surface of the stencil body 62 is substantially curved so as to correspond to the surface of the ball 11. In the embodiments, an upper surface 64 is also curved and substantially follows the curve of the lower surface.

A plurality of encoding apertures 66 are provided. The encoding apertures 66 are provided in a pattern around the icon 60, preferably towards the periphery of the stencil body 62. The encoding apertures 66 allow a user of the device to encode information on the ball 11 beyond the icon. For example, the apertures 66 may be used to encode the age of the ball 11, how many times the ball 11 has been used or similar based on the number of marks applied in the pattern. In another example, the encoding apertures 66 may also help to differentiate balls which have been marked with the same or similar icon.

A connector tab 68 is formed on an edge 70 of the stencil body 62 of the removable stencil 12. The connector tab 68 is sized and shaped to be received in the stencil retaining slot 40. The tab 68 locates the position of the stencil in the bore 34.

A catch retaining tab 72 is formed on an edge 70 of the body of the removable stencil 12 opposite the connector tab 68.

Two tab retaining grooves 74 are provided on opposite sides of the stencil body 62. The stencil shown in FIGS. 10 and 11, does not include tab retaining grooves.

A method of marking a ball, preferably a tennis ball, using the device 10 will now be briefly discussed.

In use, the device 10 is held in a hand of a user, or alternatively placed on a surface. A user locates the ball 11 within the ball receiving area 46 by inserting the ball 11 through the opening formed by the edges of the walls of the ball holder 18. The ribs 52 assist in holding the ball within the receiving area 46.

The user may align the ball 11 with the edges of the walls of the ball holder 18 and/or apertures 54. For example, if the ball 11 is a tennis ball, the seam of the tennis ball 11 may be aligned with the curved edge of the ball holder 18.

Either prior to or after the ball 11 has been located and aligned, the removable stencil 12 may be located to the stencil receiving bore 34. The user first inserts the connector tab 68 into the stencil receiving slot 40. Once the connector tab 68 is received the other end of the stencil is rotated into the stencil receiving bore 34. During this rotation, the catch retaining tab 72 causes the stencil retaining catch 42 to cam out of the locking position until the retaining tab 72 moves past the lug. The resilient retaining catch 42 is then biased back into the locking position where the lug engages with a surface of the retaining tab 72, securing the removable stencil 12 in position within the retaining bore 34.

The user pulls on the pen 14 to withdraw it from the pen holder 20. This causing the resilient catches within the cap 32 to be biased out of a locking position allowing the pen 14 to be withdrawn.

The user uses the pen 14 to mark the ball 11 by inserting through the stencil icon 60. The pen nib 55 contacts the surface of the ball 11 and leaves a mark. As the user follows the stencil icon 60, the ball 11 is marked with the icon.

Alternatively, or in combination to the use of the stencil icon 60, the user may use the encoding apertures 66 and/or the apertures 54 to add marks to the ball 11.

Once the user has finished marking, the pen 14 is inserted through slot 28 until groove 33 is engaged by resilient catches within the cap 32. The pen 14, in its resting position, is within slot 28 and cut out 30. The user withdraws the ball 11 from the ball receiving area 46.

In other embodiments, a stencil 12 may be located permanently in the ball holder 18, or omitted altogether.

Referring to FIGS. 10 and 11, a second embodiment of a ball marking device is generally indicated at 100. The ball marking device 100 of the second embodiment has substantially the same or similar features as the ball marking device 10 of the first embodiment. Reference numbers will be maintained for the same or similar features.

The second embodiment may be used in substantially the same way as the first embodiment.

The body of the device 100 is manufactured in two parts. The two parts 16a, 16b are connected or coupled together using a plurality of element tabs 76 and a plurality of element slots 78.

The plurality of element tabs 76 extends from a peripheral edge of part 16b on its proximal side that connects with part 16a. The plurality of element slots 78 are formed in a peripheral edge of part 16a on its proximal side. Each element tab 76 is shaped and positioned to be complementary to its corresponding element slot 78. This allows the element tabs 76 to be inserted within the element slots 78 to couple the two parts 16a, 16b together.

A substantially L-shaped element tab is provided on a lower section of the ball holder 18 of part 16b. An elongate element tab is provided at a rear of the pen holder 20 where the pen holder's curved side wall 22 terminates and a further elongate element tab is provided on the upper wall 24 of the pen holder 20.

A substantially L-shaped element slot is provided on the lower section of the ball holder 18 complementing the L-shaped element tab. A corresponding elongate element slot is provided at the rear of the pen holder 20 complementing the elongate element tab. A corresponding further elongate element slot is provided on the upper wall 24 of the pen holder 20 complementing the further elongate element tab.

The stencil retaining catch 42 is provided as a separate element. The stencil retaining catch 42 is substantially dog-legged in shape.

An aperture 94 for the stencil retaining catch is provided in a wall of the ball holder 18, specifically the inner wall 50. When manufactured, the stencil retaining catch 42 is disposed between the two parts 16a, 16b and a portion of the stencil retaining catch 42 is disposed in the aperture 94.

Retaining arms 95 are disposed in proximity to the aperture 94 but spaced away from the inner wall. The body of the retaining catch 42 is disposed between the retaining arms 95 and the wall in which the aperture 94 is located. The retaining arm extend from inner walls of the device 100.

The body of the stencil retaining catch 42 includes a restraining means 98, preferably a cylindrical lug, for preventing the stencil retaining means 42 from being pulled out of the device 100. The restraining means 98 is disposed between the retaining arms 95.

The pen cap 32 includes a section of larger diameter 88 proximate the open end 82. The section of larger diameter is greater than a main body 90 of the pen cap 32. The open end 82 is provided with a curved edge which tapers. A surface of the curved edge is disposed to a pen holder ridge 96 which extend around an opening of the slot 28.

The pen cap 32 is securely held in place between the lower surface of the closed end flange 84 and the surface of the curved edge by the recessed area and the pen holder ridge 96.

The embodiments described above are provided by way of example only, and various changes and modifications will be apparent to persons skilled in the art without departing from the scope of the present invention as defined by the appended claims.

1-25. (canceled)

26. A ball marking device comprising a device body including a ball holder defining a ball receiving area and a pen holder extending from the ball holder.

27. The ball marking device as claimed in claim 26, further comprising a stencil receiving portion provided in or on the ball holder.

28. The ball marking device as claimed in claim 27, in which a bore extends through the ball holder from the ball receiving area to the stencil receiving portion and a flange extends out from the bore wall and locates a removable stencil.

29. The ball marking device as claimed in claim 28, in which the ball marking device includes a stencil retaining means.

30. The ball marking device as claimed in claim 29, in which the stencil retaining means comprises a stencil collocating connector, the collocating connector comprising a tab receiving recess disposed to the bore.

31. The ball marking device as claimed in claim 29, in which the stencil retaining means comprises retaining tabs extending from an edge of the bore.

32. The ball marking device as claimed in claims 29, in which the stencil retaining means comprises a resilient catch biased towards a locking position.

33. The ball marking device as claimed in claim 26, in which an aperture extends through a wall of the ball holder to the ball receiving area, the aperture enabling marking of a ball held in the ball holder and alignment of a mark on the ball with the aperture.

34. The ball marking device as claimed in claim 26, in which the ball receiving area is concave.

35. The ball marking device as claimed in claim 26, in which the ball holder includes a ball alignment means.

36. The ball marking device as claimed in claim 26, in which the ball holder comprises a pen receiving slot, and in which one end of the pen slot includes a cap.

37. The ball marking device as claimed in claim 26, in which a lanyard connector extends from the pen holder and is formed by a curved protrusion with an aperture.

38. The ball marking device as claimed in claim 26, in which the ball marking device can be operated handheld.

39. A removable stencil used with the ball marking device as claimed in claim 27, the removable stencil comprising a stencil having a substantially concave surface and a connector.

40. The removable stencil as claimed in claim 39, in which the stencil includes a plurality of encoding apertures disposed around the stencil, and in which the plurality of encoding apertures is disposed towards the periphery of the removable stencil.

41. The removable stencil as claimed in claim 39, in which the connector is a tab connector extending from an edge of the stencil.

42. The removable stencil as claimed in claim 39, in which a catch retainer tab extends from an edge of the stencil.

43. The removable stencil as claimed in claim 39, in which a retaining groove is provided around the periphery of the removable stencil.

44. A kit of parts comprising a ball marking device as claimed in claim 26 and a pen.

45. The kit of parts as claimed in claim 44, further comprising at least one removable stencil.
